(19) United States
(12) Patent Application Publication
(10) Pub. No.: US 2025/0242295 A1
(43) Pub. Date: Jul. 31, 2025

(54) SOUR GAS FEED HEAT INTEGRATION WITH ACID GAS PRODUCTION IN GAS SWEETENING TRAINS

(71) Applicant: SAUDI ARABIAN OIL COMPANY, Dhahran (SA)

(72) Inventors: Bader Inad Alotaibi, Jubail (SA); Abdullah Al-Arifi, Dhahran (SA); Majed Aba Husain, Dhahran (SA); Abdulsalam Al-Ali, Al Qatif (SA)

(73) Assignee: SAUDI ARABIAN OIL COMPANY, Dhahran (SA)

(21) Appl. No.: 18/427,445

(22) Filed: Jan. 30, 2024

(51) Int. Cl. B01D 53/14; B01D 53/18; C10L 3/10

(52) U.S. Cl. CPC B01D 53/1462; B01D 53/1418; B01D 53/1425; B01D 53/18; C10L 3/103; C10L 3/104; B01D 2252/204; B01D 2256/24; B01D 2257/304; B01D 2257/308; B01D 2257/504; B01D 2259/65

(57) ABSTRACT

A method for producing a hot sour gas feed includes feeding a sour gas feed through a heat exchanger of a gas sweetening system (GSS), recovering a hot acid gas, feeding the hot acid gas through the heat exchanger, and heating the sour gas feed with the hot acid gas in the heat exchanger. A method for recovering hydrocarbons from a sour gas feed and reducing energy consumption of a GSS includes producing a hot sour gas feed and a cooled acid gas by feeding a sour gas feed and a hot acid gas through a heat exchanger of a GSS, separating the hot sour gas feed to provide a hydrocarbon stream and an acid rich-amine stream, regenerating an amine absorbent and a hot acid gas, and feeding the hot acid gas to the heat exchanger. The GSS includes a heat exchanger, an absorbing unit, and an amine regenerating unit.

### BACKGROUND

Amine gas treating is a process that is widely used in refineries, petrochemical plants, natural gas processing plants, and other applications. Amine gas treating, also known as amine scrubbing, gas sweetening, and acid gas removal, is a process that uses an aqueous amine solution to remove hydrogen sulfide (H₂S), carbon dioxide (CO₂), and carbonyl sulfide (COS), and other acid gases, from hydrocarbon gas streams. Gas streams containing one or more of the acid gases may be referred to as “sour gas” whether it is from a natural or a fabricated source.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments herein relate to a gas sweetening system that includes a heat exchanger including a sour gas inlet and a hot acid gas inlet, an absorbing unit in fluid communication with a hot sour gas outlet of the heat exchanger, and an amine regenerating unit comprising a hot acid gas outlet in fluid communication with the hot acid gas inlet of the heat exchanger. The heat exchanger may be configured to receive a sour gas feed having a temperature in a range from 60 to 105° F. and a hot acid gas having a temperature in a range from 225° F. to 275° F. such that a hot sour gas feed and a cooled acid gas is produced.

In another aspect, embodiments disclosed herein relate to a method for producing a hot sour gas feed. The method may include feeding a sour gas feed having a temperature in a range from 60 to 105° F. through a heat exchanger of a gas sweetening system, recovering a hot acid gas having a temperature in a range from 225° F. to 275° F. from the amine regenerating unit, feeding the hot acid gas through the heat exchanger, and heating the sour gas feed with the hot acid gas in the heat exchanger, thereby producing a hot sour gas feed and a cooled acid gas, The gas sweetening system may include an amine regenerating unit in fluid communication with the heat exchanger, and an absorbing unit in fluid communication with the heat exchanger. The hot acid gas may have a temperature that is higher than the sour gas feed, the cooled acid gas may have a temperature that is lower than the hot acid gas, and the hot sour gas feed may have a temperature that is greater than the sour gas feed.

In another aspect, embodiments herein relate to a method for recovering hydrocarbons from a sour gas feed and reducing energy consumption of a gas sweetening system. The method may include producing a hot sour gas feed and a cooled acid gas by feeding a sour gas feed having a temperature in a range from 60 to 105° F. and a hot acid gas having a temperature in a range from 225° F. to 275° F. through a heat exchanger of a gas sweetening system, separating the hot sour gas feed to provide a hydrocarbon stream and an acid rich-amine stream in the absorbing unit, regenerating an amine absorbent and a hot acid gas in the amine regenerating unit, and feeding the hot acid gas to the heat exchanger to heat the sour gas feed, The hot acid gas may have a temperature that is higher than the sour gas feed, the cooled acid gas may have a temperature that is lower than the hot acid gas, and the hot sour gas feed may have a temperature that is greater than the sour gas feed. The gas sweetening system may include an amine regenerating unit in fluid communication with the heat exchanger, and an absorbing unit in fluid communication with the heat exchanger.

In light of the structure and functions described above, embodiments of the invention may include respective means adapted to carry out various steps and functions defined above in accordance with one or more aspects and any one of the embodiments of one or more aspect described herein.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 is a gas sweetening system in accordance with one or more embodiments.

FIG. 2 is a non-limiting method of heating a sour gas feed in accordance with one or more embodiments.

FIG. 3 is a non-limiting method for recovering hydrocarbons from a sour gas feed and reducing energy consumption of a gas sweetening system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

The oil and gas industry is heavily reliant on the use of processes that extract valuable hydrocarbons from sour gas (i.e., one or more hydrocarbon gases mixed with one or more acid gases) through the use of amine-based absorption. Traditionally, acid gas removal has been performed through a physical or chemical process that results in the generation of a significant amount of waste and energy usage. For example, natural gases carry acids, namely, carbon dioxide (CO₂), hydrogen sulfide (H₂S), carbonyl sulfide (COS), among others, which hinder the production and separation of hydrocarbons. Amine solutions are often selected as acid gas removal agents (or absorbents) in a closed circulation loop commonly known as a “gas sweetening process.” Gas sweetening systems and processes utilize amine solutions to purify sour gases that include, but are not limited to, a natural sour gas, a sour gas derived from one or more hydroprocessing units (e.g., a hydrotreating unit or a hydrocracking unit), or both. Sour gas is often treated with amine solutions that flow in a cycle for continuous removal of acid gas from the sour gas feed to produce a “sweetened” gas that includes hydrocarbons. However, this process generates a significant amount of acid gas, which must be removed to ensure that the hydrocarbons are of sufficient quality and to prevent damage to downstream equipment.

For example, the incoming sour gas feed needs to be above a certain temperature, such as about 100° F., to prevent hydrocarbon condensation. Additionally, the amine absorbent must be about 15 to 20° F. higher than the sour gas feed to prevent unwanted condensation. In particular, multiple issues arise in the winter season during which ambient temperatures are at their lowest. Without a dedicated heater to the inlet sour gas feed, potential foaming and loss of product specifications within the sweetening process may occur.

Traditionally, a gas sweetening process includes a feedback controller of a control system coupled to the gas sweetening system. In such instances, the feedback controller varies an amine circulation flow rate to maintain a bottom tray temperature located proximate to an absorbing unit of a gas sweetening system. Following the treatment provided in the absorbing unit, the resultant amine, now rich with acid gas, is transported to the regenerating unit. The regenerating unit regenerates the amine in the amine solution via removal of the acid gas. The regenerated amine is then transported to the absorbing unit via one or more amine pumps such that the lean amine is recycled to the contactor to sweeten a sour gas feed. In such processes, the energy consumption in multiple units, including regeneration reboilers, amine pumping systems, and cooler fin-fan motors, is proportional to circulation rate of the gas sweetening process.

A drawback for controlling the amine circulation flow rate is that the traditional control logic does not differentiate additional factors that lead toward high tray temperature. For instance, one additional factor is the lean amine feed temperature. In instances with low performance of a lean amine cooler, an amine circulation flow rate will increase the load for cooler; thus, causing higher lean amine temperature. In turn, a traditional gas sweetening system using traditional control features without a manner in which to control the lean amine temperature, a sour gas feed temperature, or both can lead to lower separation efficiencies, increased impurities (e.g., higher acid gas content) in sweetened gas, and higher energy costs.

Another drawback of a traditional system is that there is no general means to elevate a sour gas feed temperature to approximately 100 F or above. During cooler conditions (e.g., in the winter season), a typical sour gas feed temperature only reaches about 70 F depending on ambient conditions. This lower sour gas feed temperature can lead to hydrocarbon condensation in one or more units of a traditional gas sweetening system.

In general, embodiments of the disclosure relate to systems and methods for sweetening a sour gas through the use of a heat exchanger configured to facilitate heat exchange from a hot acid gas to a sour gas feed. Embodiments in accordance with the present disclosure generally relate to processes and systems for treating “sour gas feeds,” understood to mean a stream of gas that has a “sour gas” component in it, such as acid gas including, but not limited to, H₂S, CO₂, COS, or combinations thereof. The integrated use of heat in acid gas removal involves the thermal communication of a sour gas feed fed to a gas sweetening system and a hot acid gas recovered from the gas sweetening system, thereby leading to acid gas cooler optimization as well as ensuring a sour gas feed is sufficiently heated prior to entering the absorber.

Systems and methods of such embodiments may address problems associated with energy consumption, amine circulation, acid gas slippage, sour gas slippage, and controlling one or more units of a gas sweetening system. Systems and methods of one or more embodiments are capable of minimizing the temperature difference between the recovered acid gas and sour gas feed fed to a gas sweetening system, thereby reducing the energy required to bring the sour gas feed up to an operational temperature for treatment in an absorption unit and avoid any operational limitations.

### Gas Sweetening System

Generally, embodiments in accordance with the present disclosure involve a gas sweetening system (e.g., a gas sweetening train) that includes a heat exchanger in fluid communication with an absorbing unit and a regenerating unit. The heat exchanger may be coupled to the gas sweetening system at a location upstream of the absorbing unit. The heat exchanger may be coupled to an inlet flow line that feeds a sour gas into an absorbing unit of the gas sweetening system. In such embodiments, the heat exchanger is configured to receive a crude sour gas from a sour gas source. The heat exchanger may be configured to receive a hot acid gas generated from an amine regenerating unit of the gas sweetening system.

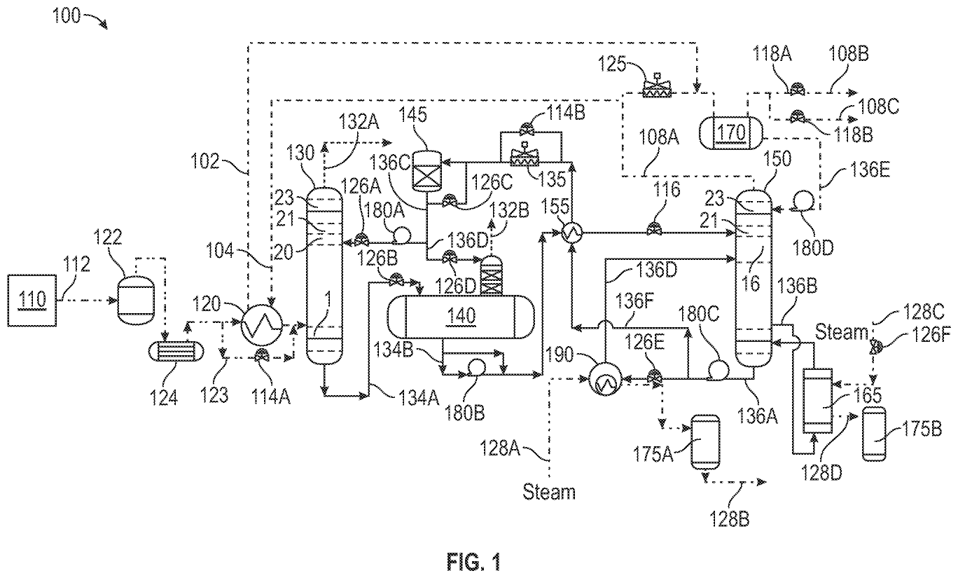

FIG. 1 shows a schematic of an exemplary gas sweetening system 100 in accordance with one or more embodiments. As shown in FIG. 1, the gas sweetening system may include a plurality of fluid pumps (180A-180D), a plurality of lean amine flow lines (136A-136E), a plurality of rich amine flow lines (134A-134B), acid gas flow lines (102, 104, and 108A-108C), sweetened gas flow lines (132A-132B)), one or more amine coolers (e.g., 135), one or more acid gas coolers (e.g., 125), one or more particulate filters (not shown), one or more temperature control valves (114A-114B), one or more pressure control valves (118A-118B), one or more level control valves (116), one or more additional valves (126A-126F) one or more splitting joints (not shown), a water make up feed (not shown), or any combination thereof. In some embodiments, valve 126A is a flow control valve, which may be a Globe flow control valve. Valves 126B and 126C may each be a level control valve for an absorbing unit, which may be an amine contactor absorbing unit. In such embodiments, valves can each be a Globe level control valve. Valves 126D and 126F may each be a flow control valve. Each flow control valve may be a Globe flow control valve. Valve 126E may be a level control valve, such as a Globe level control valve. In some embodiments, gas sweetening system 100 includes a plurality of gas sweetening units that may be electrically connected to a control unit. In some embodiments, the control unit is coupled to a plurality of sensors (not shown) coupled to one or more gas sweetening units of the gas sweetening system 100.

As presented herein, the term “lean” as in a “lean amine” or “lean amine solution” refers to the reaction capacity of the amines in the solution, that is, the amines in the amine solution are operable to react with acid gases. A “rich” stream as in “rich amine” or “rich amine solution,” on the other hand, means that a significant portion of the amines in the amine solution have reacted with an acid gas to form amine-acid gas products, such as acid sulphides, and therefore do not have the capacity to perform additional reactions. The amine absorption reaction is reversible, so when the conditions are reversed, such as in a “regeneration unit,” the amine-acid gas products break down back into the respective amines in solution and dissolved acid gas. The acid gas bubbles out of the solution and the amine solution is once again considered “lean.” The term “acid gas loading” refers to a reaction between the acid gas and amine such that the acid gas is selectively removed from the sour gas feed.

The gas sweetening system may include a heat exchanger 120. The heat exchanger may include a first section in thermal communication with a second section of the heat exchanger. The first section of heat exchanger 120 may receive a sour gas feed. The second section may receive a hot acid gas such that heat from the hot acid gas is transferred to the sour gas feed. The first section of the heat exchanger may include an inner tube portion. The second section may include an outer shell portion of the heat exchanger such that the hot acid gas flows through the outer shell to heat a sour gas feed in the inner tube portion. In such embodiments, the heat exchanger is configured to preheat the sour gas feed with heat from the hot acid gas. The second section including an outer shell portion may surround the first section including the inner tube portion of the heat exchanger. Heat exchanger 120 may include material suitable for mitigating or preventing corrosion from acid gas. For example, heat exchanger 120 may include material similar to an acid gas cooler (e.g., an acid gas fin-fan cooler). In particular embodiments, heat exchanger includes stainless steel configured to withstand or prevent corrosion from contact with the acid gas, such as grade 316L stainless steel. For example, one or more inner surfaces of the heat exchanger, such as the surface of the tube portion that is in contact with the sour gas, the surface of the shell portion in contact with the acid gas, or both, includes a surface coating that includes grade 316L stainless steel.

The heat exchanger 120 of the gas sweetening system 100 may be configured to receive a sour gas feed from sour gas source 110 via flow line 112 and produce a hot sour gas feed. In some embodiments, seasonal conditions can affect the sour gas feed temperature. A gas sweetening system in operation during winter conditions, may have a relatively cooler sour gas feed temperature due to heat loss to the environment as compared to a sour gas feed of a gas sweetening system as compared during summer conditions. In one or more particular embodiments, the sour gas feed has a temperature in a range from about 55° F. to about 110° F. In some embodiments, the sour gas feed has a temperature with a lower limit of any one of 55, 58, 60, 62, 65, 68, and 70° F. and an upper limit of any one of 70, 72, 75, 80, 85, 90, 95, 98, 100, 102, 105, 107, and 110° F., where any lower limit can be paired with any mathematically compatible upper limit. The hot sour gas feed may have a temperature in a range having a lower limit of any one of about 100° F., 105, 110, and 115° F. and an upper limit of any one of 110° F., 115, 120, and 125° F. In some embodiments, the hot sour gas has a temperature of at least 100° F. In some embodiments, the hot sour gas has a temperature of at least 105° F. In some embodiments, the maximum temperature for a hot sour gas temperature entering an absorbing unit of a gas sweetening system is about 125° F. and a temperature of a lean amine entering the absorbing unit of at least 140° F.

A knockout drum 122, a coalescer 124, or both may be included on flow line 112 such that the sour gas feed passes through knockout drum 122, coalescer 124, or both prior to entering the heat exchanger 120. In some embodiments, a portion of the sour gas feed is split prior to entering the heat exchanger and passed through a temperature control valve 114A (e.g., via flow line 123) to monitor the temperature of the sour gas feed entering the absorbing unit 130. In such embodiments, heat exchanger 120 is in fluid communication with absorbing unit 130.

In some embodiments, the heat exchanger 120 is configured to receive a hot acid gas via flow line 104. The hot acid gas may be an overhead effluent recovered from a regenerating unit 150. In such embodiments, heat exchanger 120 is in fluid communication with a regenerating unit 150. In some embodiments, the hot acid gas has a temperature in a range from about 225° F. to about 275° F. The hot acid gas may have a temperature in a range having a lower limit of any one of about 225° F., 230, 235, 240, and 245° F. with an upper limit of any one of 250, 255, 260, 265, 270, and about 275° F., where any lower limit can be paired with any mathematically compatible upper limit.

As mentioned above, the gas sweetening system 100 may include a heat exchanger 120 in fluid communication with an absorbing unit 130 and a regenerating unit 150. A hydrocarbon outlet line 132A of absorbing unit 130 may be in fluid communication with a sweet gas coalescing unit (not shown). The sweet gas coalescing unit may be configured to receive a sweetened gas from absorbing unit 130. The absorbing unit 130 receives a lean amine solution via flow line 136C to treat a heated sour gas received by the absorbing unit 130 from heat exchanger 120 to produce a sweetened gas that includes hydrocarbons and a rich amine.

In some embodiments, absorbing unit 130 receives a heated sour gas feed from a heat exchanger 120 via sour gas flow line 112, a fresh lean amine (or a fresh lean amine solution) from a fresh lean amine flow line (not shown), and a regenerated lean amine (e.g., via regenerated lean amine flow line 136C), such that the absorbing unit receives a recycled amine to completes an “amine recycle” or “amine loop.”

Absorbing unit 130 promotes acid gas loading of the lean amine to form a rich amine and a sweetened gas by promoting a reaction as described above. As mentioned above, the sweetened gas may be passed to one or more downstream units, may be collected in a collection unit, or combinations thereof.

The lean amine of one or more embodiments is not particularly limited and may comprise an amine that is suitable for the removal of a desired amount of acid gas from the sour gas feed to produce a sweetened gas. In some embodiments, the lean amine consists essentially of an amine that is capable of removing a desired amount of acid gas from the sour gas feed to produce a sweetened gas. The lean amine may include, but is not limited to, one or more selected from the group comprising primary amines, secondary amines, tertiary amines, alkanolamines, and combinations thereof. In some embodiments, the amine solution may include, but is not limited to, monoethanolamine (MEA), diethanolamine (DEA), diglycolamine (DGA), diisopropanolamine (DIPA), N-methyldiethanolamine (MDEA), triethanolamine (TEA), piperazine (PZ), 2-amino-2-methyl-1-propanol (AMP), or combinations thereof.

In some embodiments, the amine circulating through the gas sweetening system 100 is an aqueous amine solution. A lean amine solution of one or more embodiments may have an amine concentration in the range of about 15 to about 50 percent by weight (wt. %) of the lean amine solution. For example, the lean amine solution of one or more embodiments may have an amine concentration in a range having a lower limit of any of 15, 20, 25, 30, and 35 wt. %, and an upper limit of any of 20, 25, 30, 35, 40, 45, and 50 wt. %, where any lower limit may be used in combination with any mathematically compatible upper limit. The amine concentration of one or more embodiments may be dependent on the type of the amine used. For example, the lean amine solution may have an amine concentration of about 50 wt. %. In another example, the amine solution may have an amine concentration of about 18 wt. %. The lean amine solution may have a residual amount of an acid gas, such as hydrogen sulfide, to mitigate equipment and piping corrosion. In some embodiments, the loading of hydrogen sulfide to amine in the lean amine solution is equal to or greater than about 0.010 mol/mol amine, such as in having a hydrogen sulfide loading a range of from about 0.010 to about 0.015 mol/mol amine.

In some embodiments, the balance of lean amine solution includes water. For example, the lean amine solution may include water in an amount from about 50 to about 85 wt % based on the total weight of the lean amine solution. The lean amine solution of one or more embodiments may include water in a range having a lower limit of any one of 50, 55, 60, 65, 70, 75, and 80 wt. %, and an upper limit of any one of 70, 75, 80, and 85 wt. %, where any lower limit may be used in combination with any mathematically compatible upper limit. The water may be distilled water, deionized water, tap water, fresh water from surface or subsurface sources, production water, formation water, natural and synthetic brines, brackish water, natural and synthetic sea water, potable water, non-potable water, other waters, and combinations thereof, that are suitable for use in a gas sweetening system. In one or more embodiments, the water used may naturally contain contaminants, such as salts, ions, minerals, organics, and combinations thereof, as long as the contaminants do not interfere with the separation of acid gas and the recovery of hydrocarbons from a sour gas feed.

In some embodiments, the gas sweetening system 100 is configured to circulate a rich amine from an absorbing unit to a regenerating unit. The rich amine may include an amine that has been subjected to a reaction with an acid gas in a sour gas feed. In some embodiments, the rich amine consists essentially of an amine that has been subjected to a reaction with an acid gas in a sour gas feed. In some embodiments, the rich amine may be an aqueous rich amine solution. In some embodiments, the maximum amount of acid gas loading in an absorbing unit to form a rich amine solution is about 0.45 moles of acid gas per mole of amine (mol acid gas/mol amine) or less. In such embodiments, the rich amine solution includes water in an amount in a range from about 55% to about 60% by mol (mol %) based the total number of moles present in the rich amine solution. In some embodiments, the rich amine, or rich amine solution, has other components that were merely dissolved in the absorbing unit 130 that are recoverable. In some embodiments, the rich amine solution has a free acid gas concentration that is significant. For example, the free acid gas concentration is in a range of from about 1 to about 4 mol % of the rich amine solution may comprise “free” acid gas (that is, acid gas that is unreacted with amines; merely dissolved in water). There may also be smaller yet recoverable amounts of hydrogen, light hydrocarbons, and medium hydrocarbons in the rich amine solution, in rich amine flow lines, or in the absorbing unit 130.

Referring back to FIG. 1, a rich amine may be transferred to a flash drum 140 via rich amine outlet flow line 134A. Flash drum 140 may separate residual sweetened gas, from a rich amine such that residual sweetened gas is recovered via sweet gas line 132B. In some embodiments, a residual lean amine may be collected and recycled from flash drum 140 to absorbing unit 130.

The flash drum 140 is operated at a reduced pressure compared to absorbing unit 130. This causes the introduced rich amine, or rich amine solution, to drop from a greater pressure condition to the reduced pressure condition, creating the “flash” that results in gases escaping the rich amine solution through a turbulent boil. In some configurations, internal structures of the flash drum are configured to spread the introduced rich amine thinly so that the amount of distance a coalescing gas in the liquid has to travel to the surface of the liquid and into the gas phase is reduced, facilitating degassing of the liquid. Atomizing nozzles, packing, distributor plates, and “smash” or “slam” plates (that is, a sacrificial barrier that the fluid is introduced onto to spray the liquid thinly in all directions) are known and appreciated.

Flash drum 140 forms at least two products from the rich amine solution: flashed sour gas and flash drum rich amine solution. In some embodiments, flashed sour gas is passed back toward the absorbing unit via a flashed sour gas flow line (not shown). The flashed sour gas may include hydrogen gas (i.e., H₂). In one or more embodiments, the flashed sour gas may be comprised of hydrogen gas in a concentration of about 10 mol % or less. In some embodiments, the flashed sour gas is substantially free of hydrogen gas.

The flashed sour gas may have a C₁₋₄ concentration that is a significant portion of the gas. In one or more embodiments, the flashed sour gas may be comprised of C₁₋₄ in a concentration having a range of from about 1 mol % to about 99 mol %. In one or more embodiments, the flashed sour gas may be comprised of C₁₋₄ concentration in a range having a lower limit of any one of 1, 5, 10, 20, 30, 40, 50, 60, 70 and 75 mol %, and an upper limit of any of 5, 10, 20, 30, 40, 50, 70, 90 95, and 99 mol %, where any lower limit may be used in combination with any mathematically-compatible upper limit. The flashed sour gas may have a C₅₊ concentration that is an incidental portion of the gas.

The flashed sour gas may be substantially free of hydrogen sulfide (H₂S). In some embodiments, lean amine is passed through valve 126C to a flash gas contactor in flash drum 140. In such embodiments, the flashed sour gas may have trace amounts of carbon dioxide (CO₂).

In some embodiments, the flash drum rich amine solution includes a rich amine. The flash drum rich amine solution from the bottom of the flash drum may include several components. Like the rich amine from which it originated, flash drum rich amine mostly contains rich amine (about 35 to about 40 mol %) and may include water (e.g., from about 55 to about 60 mol %). Flash drum rich amine solution may be passed via rich amine outlet flow line 134B with pump 180B from flash drum 140 to regenerating unit 150. In some embodiments, the rich amine passed to the regenerating unit 150 from flash drum 140 is passed through a lean/rich amine exchanger such that the rich amine feed is heated by a lean amine effluent recovered from the regenerating unit.

Regenerating unit 150 may be configured to regenerate a lean amine and a hot acid gas from a rich amine via a reverse reaction as described above. A hot acid gas may be passed from regenerating unit 150 to acid gas outlet lines 108B and 108C via line 108A. The hot acid gas may be passed through line 108A to a cooler 125 to generate a cooled acid gas that may be passed to a reflux drum 170. In some embodiments, cooler 125 may be one or more fin-fan coolers capable of cooling the hot acid gas to a temperature of about 150° F. or below (e.g., about 140° F.). The acid gas collected in reflux drum 170 may be passed to a sulfur recovery unit (not shown) via outlet line 108B, to flare via outlet line 108C, or both. As mentioned above, at least a portion of the hot acid gas is passed through line 108A to 104 that enters a heat exchanger 120 to form a cooled acid gas. The cooled acid gas may have a temperature with a lower limit of any one of 120, 125, 130, 135, and 140° F. and an upper limit of any one of 140, 145, 150, 155, and 160° F., where any lower limit can be paired with any mathematically compatible upper limit. The cooled acid gas generated by the heat exchanger may be recycled back to join with a cooled acid gas generated by cooler 125 via line 102 that may be collected in reflux drum 170. In some embodiments, residual lean amine collected in reflux drum 170 may be passed back to regenerating unit 150 via flow line 136E with pump 180D.

Regenerating unit 150 may include one or more lean amine outlet flow lines (e.g., lines 136A and 136B). Outlet flow line 136A may be in fluid connection with flow line 136F. Flow line 136F may pass a portion of the regenerated lean amine to cooler 135 with pump 180C. The regenerated and cooled lean amine may be passed from cooler 135 to absorbing unit 130 via regenerated lean amine flow line 136C. In some embodiments, a portion of regenerated and cooled lean amine may be passed via lean amine flow line 136C to one or more particulate filters 145 to separate solids from the lean amine. The lean amine passed through one or more particulate filters 145 may then be passed to absorbing unit 130

In some embodiments, a portion of the regenerated lean amine is passed to an amine reboiler 165 via outlet line 136B to remove residual acid gas. In such embodiments, the regenerated lean amine may be reboiled and fed back to regenerating unit 150. The reboiler may be configured to reboil the regenerated lean amine with steam via a steam feed line 128C. The steam may be recovered in a steam condensation drum 175B via steam flow line 128D.

Regenerating unit 150 may include a regenerated lean amine outlet flow line 136A, which passes regenerated lean amine to amine reclaimer 190. Amine reclaimer 190 may be used to treat thermally stable salts in a lean amine solution, such as with the addition of a more basic compound than the amine. Generated lean amine vapor may be passed from amine reclaimer 190 to regenerating unit 150 via vapor flow line 136D, further recycled to absorbing unit 130, or combinations thereof. In some embodiments, the regenerated lean amine fed to amine reclaimer 190 is treated with steam and fed back to regenerating unit 150 via line 136D. Steam fed to reclaimer 190 may be recovered via steam flow line 128A and passed to condensing drum 175A. Condensing drum 175A may include a steam outlet line 128B.

In some embodiments, the gas sweetening system 100 includes a plurality of sensors includes sensors selected from temperature sensors, pressure sensors, flow rate sensors, liquid level sensors, or any combination thereof. In some embodiments, the plurality of sensors may measure/acquire one or more properties of the plurality of gas sweetening units such that the plurality of sensors acquires gas sweetening data. The plurality of sensors may include a water feed flow rate sensor, a lean amine inlet flow rate sensor, a lean amine inlet temperature sensor, a sour gas inlet flow rate sensor, a sour gas inlet temperature sensor, an acid gas temperature control valve, an overhead pressure transmitter coupled to absorbing unit 130, an overhead pressure sensor coupled to regenerating unit 150, a liquid level sensor coupled to regenerating unit 150, or any combination thereof. In some embodiments, the gas sweetening system 100 includes one or more flow meters that monitor the acid gas flow distribution between the acid gas cooler 125 and the heat exchanger 120.

### Method for Heating a Sour Gas Feed

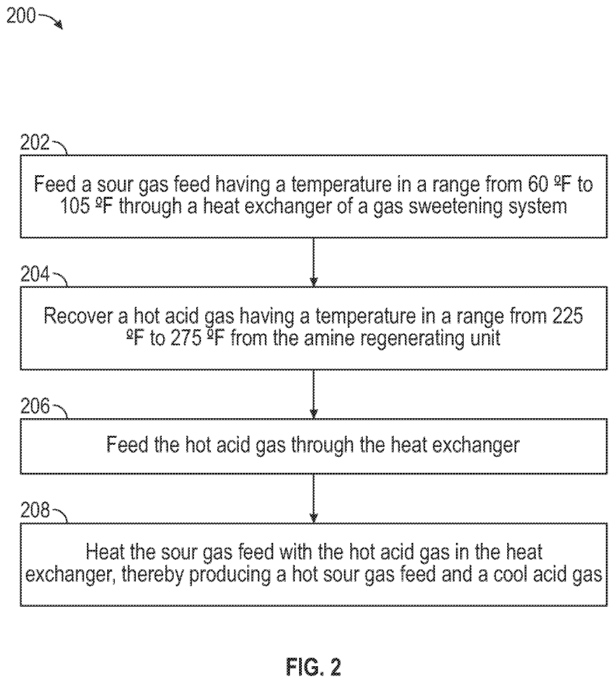

In another aspect, one or more embodiments herein relate to a method for heating a sour gas feed. The method may be conducted in a gas sweetening system as described above (e.g., gas sweetening system 100 of FIG. 1). FIG. 2 shows a non-limiting method 200 of heating a sour gas feed in accordance with one or more embodiments. The steps of method 200 may be performed sequentially or simultaneously. Step 202 of FIG. 2 includes feeding a sour gas feed having a temperature in a range from about 55 to about 105° F. through a heat exchanger of a gas sweetening system to produce a hot sour gas feed. The heat exchanger may be in fluid communication with an absorbing unit and a regenerating unit of the gas sweetening system. The hot sour gas feed may be passed to the absorbing unit of the gas sweetening system.

In some embodiments, a hot acid gas having a temperature in a range from 225° F. to 275° F. is recovered from the amine regenerating unit of the gas sweetening system in step 204. The recovered hot acid gas may be fed through the heat exchanger in step 206 to generate a cooled acid gas by transferring heat from the hot acid gas to the sour gas feed. The heat exchanger may facilitate the transfer of heat from the hot acid gas feed to the sour gas feed such that the sour gas feed and the hot acid gas feed are in thermal communication. The hot acid gas feed may heat the sour gas feed as shown in FIG. 2, step 208 such that the heat exchanger produces a hot sour gas feed and a cooled acid gas.

In some embodiments, the flow rate of the acid gas through the heat exchanger can be controlled by a temperature control valve. The temperature control valve may monitor an outlet sour gas temperature such that the temperature and energy load on the acid gas coolers can be reduced. In such embodiments, the acid gas temperature is maintained at a set limit despite the inclusion of the acid gas and sour gas heat exchanger.

Method for Recovering Hydrocarbons from a Sour Gas Feed and Reducing Energy Consumption of a Gas Sweetening System

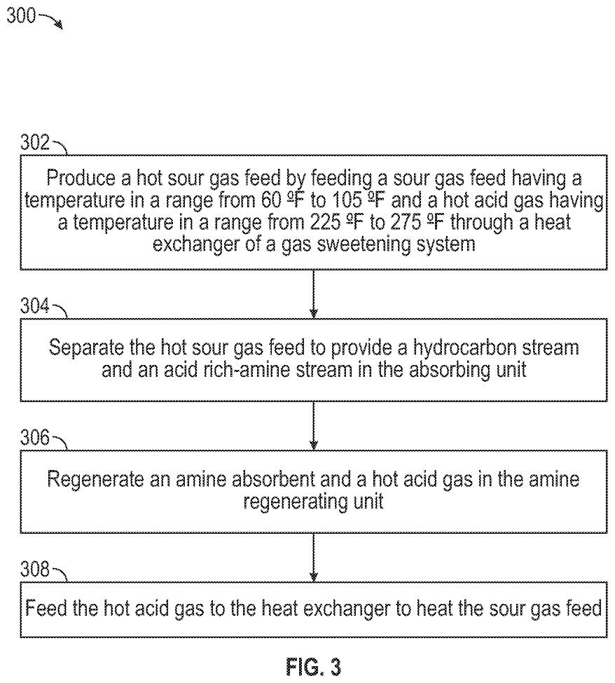

In another aspect, embodiments herein relate to a method for recovering hydrocarbons from a sour gas feed and reducing energy consumption of a gas sweetening system. FIG. 3 shows a non-limiting example of a method 300 for the recovery of hydrocarbons and the simultaneous reduction of energy consumption in a gas sweetening system. The steps of the method 300 may be performed sequentially or simultaneously. The method 300 may be conducted using a gas sweetening system as described above. The method 300 may include step 302, which includes producing a heated sour gas feed by a method for heating a sour gas feed (e.g., method 200 of FIG. 2) as described above. The method 300 may include separating the hot sour gas feed to produce a hydrocarbon stream and an acid rich-amine stream in an absorbing unit of the gas sweetening system in step 304. In some embodiments, hydrocarbons can be recovered from a flash drum in fluid communication with the absorbing unit of the gas sweetening system.

The method 300 may include regenerating an amine absorbent and a hot acid gas in the amine regenerating unit in step 306. The hot acid gas may be cooled and collected for sulfur recovery, sent to flare, or both. In one or more particular embodiments, the hot acid gas is recycled and fed to a heat exchanger of the gas sweetening system (e.g., step 308 of method 300), such that thermal energy of the gas sweetening system is substantially conserved. In such embodiments, energy requirements of a cooler for the hot acid gas effluent are reduced.

Embodiments of the present disclosure may provide at least one of the following advantages. One or more embodiments presented herein can reduce the amount of energy required to operate the gas sweetening and amine-based absorption process, resulting in cost savings. Additionally, one or more embodiments may provide for temperature mitigation during winter seasons, during which the feed temperature of the sour gas might affect the efficacy of the absorption process. Further, one or more embodiments may ensure that the hydrocarbons extracted and recovered from the sour gas feed are of sufficient quality for commercial viability.

The singular forms “a,” “an,” and “the” include plural referents, unless the context clearly dictates otherwise. As used here and in the appended claims, the words “comprise,” “has,” and “include” and all grammatical variations thereof are each intended to have an open, non-limiting meaning that does not exclude additional elements or steps. When the words “approximately” or “about” is used, this term may mean that there can be a variance in value of up to +10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

The term “mostly” means greater than 50.00% of the overall composition by the stated unit of measure (mass/volume/mole). The term “substantial” means greater than 10.00% but less than or equal to 50.00% (that is, not a majority) of the overall composition by the stated unit of measure (mass/volume/mole). The term “significant” means greater than 1.00% but less than or equal to 10.00% (that is, not substantial) of the overall composition by the stated unit of measure (mass/volume/mole). The term “detectable” means equal to or greater than 0.01% but less than or equal to 1.00% (that is, not significant) of the overall composition by the stated unit of measure (mass/volume/mole). The term “incidental” means less than 0.01% of the overall composition by the stated unit of measure (mass/volume/mole). However, “incidental” does not exclude the material from the composition; rather, the term indicates that, if determined to be present using industry-available analytical equipment, its presence is de minimus for the purposes of this application.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for producing a hot sour gas feed, the method comprising:
feeding a sour gas feed having a temperature in a range from 60 to 105° F. through a heat exchanger of a gas sweetening system, wherein the gas sweetening system comprises:
an amine regenerating unit in fluid communication with the heat exchanger, and
an absorbing unit in fluid communication with the heat exchanger;
recovering a hot acid gas having a temperature in a range from 225° F. to 275° F. from the amine regenerating unit;
feeding the hot acid gas through the heat exchanger; and
heating the sour gas feed with the hot acid gas in the heat exchanger, thereby producing a hot sour gas feed and a cooled acid gas,
wherein the hot acid gas has a temperature that is higher than the sour gas feed, the cooled acid gas has a temperature that is lower than the hot acid gas, and the hot sour gas feed has a temperature that is greater than the sour gas feed.

2. The method of claim 1, wherein the hot sour gas feed has a temperature of to at least 100 OF in the heat exchanger.

3. The method of claim 1, wherein the cooled acid gas has a temperature in a range from 120° F. to 160° F.

4. The method of claim 1, wherein the sour gas feed comprises an acid gas and a hydrocarbon stream.

5. The method of claim 4, further comprising recovering the hydrocarbon stream from the absorbing unit.

6. The method of claim 1, wherein feeding the sour gas feed and the hot acid gas through the heat exchanger comprises:
feeding the sour gas feed through a first section of the heat exchanger; and
feeding the hot acid gas through a second section of the heat exchanger.

7. The method of claim 6, wherein the first section and the second section of the heat exchanger are in thermal communication such that heat from the hot acid gas is transferred to the sour gas feed.

8. The method of claim 6, wherein the first section comprises an internal tube.

9. The method of claim 8, wherein the second section comprises a shell portion of the heat exchanger that surrounds the internal tube of the first section.

10. A method for recovering hydrocarbons from a sour gas feed and reducing energy consumption of a gas sweetening system, the method comprising:
producing a hot sour gas feed and a cooled acid gas by feeding a sour gas feed having a temperature in a range from 60 to 105° F. and a hot acid gas having a temperature in a range from 225° F. to 275° F. through a heat exchanger of a gas sweetening system, wherein the gas sweetening system comprises:
an amine regenerating unit in fluid communication with the heat exchanger, and
an absorbing unit in fluid communication with the heat exchanger;
separating the hot sour gas feed to provide a hydrocarbon stream and an acid rich-amine stream in the absorbing unit;
regenerating an amine absorbent and a hot acid gas in the amine regenerating unit; and
feeding the hot acid gas to the heat exchanger to heat the sour gas feed,
wherein the hot acid gas has a temperature that is higher than the sour gas feed, the cooled acid gas has a temperature that is lower than the hot acid gas, and the hot sour gas feed has a temperature that is greater than the sour gas feed.

11. The method of claim 10, further comprising recovering the hydrocarbon stream from the absorbing unit.

12. The method of claim 10, wherein the hot sour gas feed has a temperature in a range of at least 100° F., and wherein the cooled acid gas has a temperature in a range from 120° F. to 160° F.

13. The method of claim 10, wherein the sour gas feed is fed to an inner tube portion of the heat exchanger, and the hot acid gas is fed to a shell portion surrounding the inner tube portion of the heat exchanger.

14. A gas sweetening system comprising:
a heat exchanger comprising a sour gas inlet and a hot acid gas inlet, wherein the heat exchanger is configured to receive a sour gas feed having a temperature in a range from 60 to 105° F. and a hot acid gas having a temperature in a range from 225° F. to 275° F. such that a hot sour gas feed and a cooled acid gas is produced;
an absorbing unit in fluid communication with a hot sour gas outlet of the heat exchanger; and
an amine regenerating unit comprising a hot acid gas outlet in fluid communication with the hot acid gas inlet of the heat exchanger.

15. The gas sweetening system of claim 14, wherein the sour gas feed comprises an acid gas and a hydrocarbon stream.

16. The gas sweetening system of claim 14, wherein the sour gas feed is fed to the heat exchanger at a temperature in a range from 60 to 105° F., and wherein the hot sour gas feed has a temperature of at least 100° F.

17. The gas sweetening system of claim 14, wherein the hot acid gas has a temperature in a range from 225° F. to 275° F.

18. The gas sweetening system of claim 14, wherein the heat exchanger comprises an inner tube portion configured to receive the sour gas feed and a shell portion surrounding the inner tube portion, wherein the shell portion is configured to receive the hot acid gas.

19. The gas sweetening system of claim 18, wherein the inner tube portion and the shell portion are in thermal communication such that heat is transferred from the hot acid gas in the shell portion to the sour gas feed of the inner tube portion.

20. The gas sweetening system of claim 14, wherein the heat exchanger comprises grade 316L stainless steel.
